(19) United States
(12) Patent Application Publication
(10) Pub. No.: US 2009/0014491 A1
(43) Pub. Date: Jan. 15, 2009

(54) Packet structure, such as for a film strip

(75) Inventors: Richard C. Fuisz, McLean, VA (US); Bruce D. Detwiler, Boyertown, PA (US)

Correspondence Address: HOFFMANN & BARON, LLP, 6900 JERICHO TURNPIKE, SYOSSET, NY, 11791, US

(73) Assignee: MonoSol Rx, LLC.

(21) Appl. No.: 12/072,807

(22) Filed: Feb. 28, 2008

Related U.S. Application Data
(60) Provisional application No. 60/904,727, filed on Mar. 2, 2007.

(51) Int. Cl. B26F 3/02; B65D 27/34

(52) U.S. Cl. 225/1; 229/313

(57) ABSTRACT

The packet structure includes an envelope structure and a tear structure therein. The tear structure provides for tearing of a specific section of the envelope structure to gain access to a film strip which is stored within an internal cavity in the envelope structure. The tear structure has a reduced resistance to tearing relative to an adjoining portion of the envelope structure. The reduced resistance to tearing directs the tearing of the envelope structure to a specific section thereof. The tear structure may alternatively have a pull-string attached within the envelope structure and extending through an aperture therein to a location outside of the envelope structure. The location of the aperture and attachment of the pull-string within the envelope structure directs the tearing of the envelope structure to a specific section thereof.

### CROSS-REFERENCE TO RELATED APPLICATION

This patent application claims priority to and the benefit of U.S. Provisional Patent Application No. 60/904,727 filed on Mar. 2, 2007, which is incorporated by reference herein.

### FIELD OF THE INVENTION

The present invention relates generally to a pouch or packet and, more specifically, to a pouch or packet which may be opened for the removal of a film strip contained therein.

### BACKGROUND OF THE INVENTION

Pharmaceuticals and similar substances are typically required to be ingested in relatively precise amounts. One technique for providing pharmaceuticals and such relatively precise amounts for ingestion is to impregnate a dissolvable film strip with the relatively precise amount of the pharmaceutical. The user may then place the film strip in their mouth and receive the relatively precise amount of the pharmaceutical.

Medications are frequently applied to cuts and wounds to facilitate the healing thereof. One technique for applying such medications to cuts and wounds on the skin is to impregnate a film strip with the medication. The user may then place the film strip on the cut or wound and, frequently, the adjacent skin, such that the medication on the film strip is transferred to the cut or wound. The film strip may be dissolvable or removed after the medication has been transferred to the cut or wound.

Such impregnated film strips may be contained within a pouch or packet for storage before ingestion or application by the user. Such pouches or packets provide protection to the film strip and maintain the pharmaceutical or medication in a controlled environment before ingestion or application thereof by the user. The pouches or packets are typically opened by the user manually tearing the pouch or packet to gain access to the film strip therein.

Manual tearing of the pouch or packet may involve the user removing an edge section of the pouch or packet to open the cavity therein in which the film strip is contained. It is typically required that the removal of the edge section not affect the film strip, such as by tearing or otherwise. Having the film strip be unaffected by the removal of the edge section may be provided by limiting the size of the edge section of the pouch or packet which is removed, such as by limiting any overlap of the edge section which is removed with the film strip contained in the pouch or packet. Accordingly, limiting the size of the edge section of the pouch or packet which is removed to open the cavity therein is advantageous.

### SUMMARY OF THE INVENTION

The packet structure of the present invention includes an envelope structure and a tear structure formed in the envelope structure. The tear structure provides for tearing of a specific section of the envelope structure to gain access to a film strip which is stored within an internal cavity in the envelope structure. The tear structure may provide for the section of the envelope structure which is torn to have a limited size such that the film strip which is stored within the internal cavity is not affected by the tearing of the envelope structure provide access to the film strip within the internal cavity.

The tear structure is provided by one embodiment which has a reduced resistance to tearing relative to an adjoining portion of the envelope structure. The reduced resistance to tearing directs the tearing of the envelope structure to a specific section thereof which has the limited size. The tearing of the envelope structure is provided by grasping thereof by the user and tearing a detachable edge from the envelope structure for access to the film strip stored within the internal cavity.

The tear structure may alternatively have a pull-string attached within the envelope structure and extending through an aperture therein to a location outside of the envelope structure. The location of the aperture and attachment of the pull-string within the envelope structure directs the tearing of the envelope structure to a specific section thereof. The tearing of the envelope structure is provided by displacing the pull-string relative to the envelope structure.

These and other features of the invention will be more fully understood from the following description of specific embodiments of the invention taken together with the accompanying drawings.

### BRIEF DESCRIPTION OF THE DRAWINGS

In the drawings:

FIG. 1 is a top plan view of the packet structure of the present invention, the packet structure being shown as including an envelope structure and a tear structure having a reduced resistance to tearing relative to the envelope structure;

FIG. 2 is a side elevation of the packet structure of FIG. 1, showing the handle structure which results from the initial tearing of the packet structure; and

FIG. 3 is a top plan view of an alternative embodiment of the packet structure of FIG. 1, the packet structure being shown as having an envelope structure and a tear structure which includes a pull-string.

Corresponding reference characters indicate corresponding parts throughout the several views of the drawings.

### DETAILED DESCRIPTION OF THE INVENTION

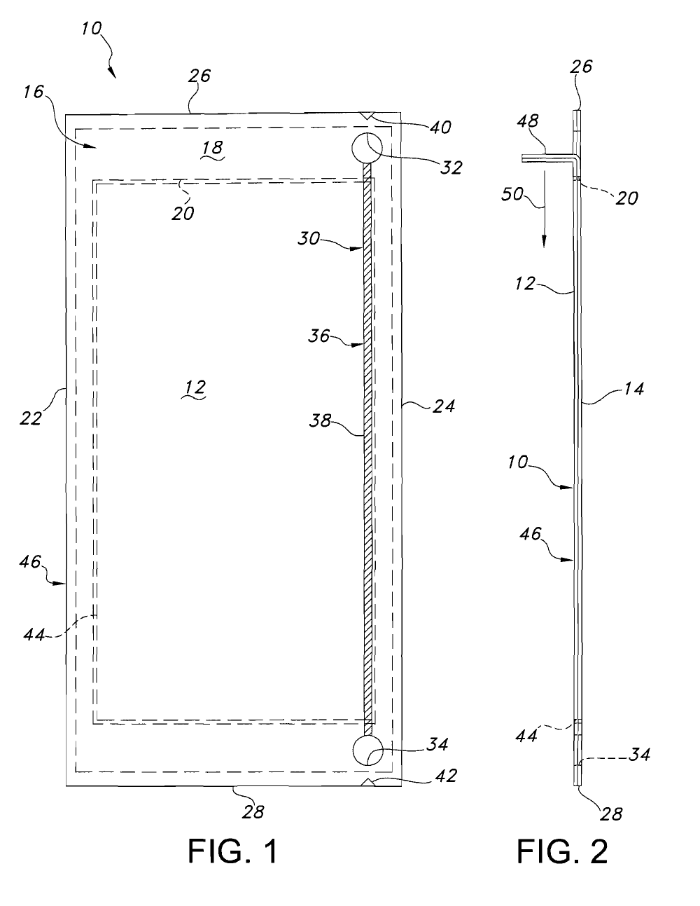

Referring to the drawings and more specifically to FIG. 1, the pouch or packet structure 10 includes first and second panels 12, 14. The first and second panels 12, 14 are sealed to one another to form an envelope structure 16 which has a peripheral sealed region 18 defined by the regions of the first and second panels 12, 14 which are sealed to one another. The envelope structure 16 has an internal cavity 20 within the sealed region 18. The envelope structure 16 has a lateral edge 22, detachable edge 24, and end edges 26, 28.

The packet structure 10 has a tear structure 30 which includes a first hole 32 extending through the section of the sealed region 18 such that at least part of the first hole is between the cavity 20 and end edge 26, as shown in FIG. 1. The tear structure 30 includes a second hole 34 located in the section of the sealed region 18 such that at least part of the second hole is between the cavity 20 and end edge 28.

The tear structure 30 includes a directional structure 36 defined by a score structure 38. The score structure 38 is elongate and extends between the first and second holes 32, 34 in intersecting relation thereto, as shown in FIG. 1. The score structure 38 has a reduced resistance to tearing relative to the adjoining portions of the envelope structure 16. The score structure 38 is defined by a scratch, incision, or reduced thickness of the first and second panels 12, 14. The score structure 38 is continuous and located in the sections of the first and second panels 12, 14 which define the cavity 20. Alternatives to the score structure 38 are possible for the directional structure 36, such as elongate perforations or slits.

The tear structure 30 includes a first indicia 40 which is affixed to the first and second panels 12, 14 generally adjacent to the end edge 26. The first indicia 40 is located on the panels 12, 14 such that the first hole 32 is between the first indicia and score structure 38, as shown in FIG. 1. The tear structure 30 includes a second indicia 42 which is affixed to the first and second panels 12, 14 generally adjacent to the end edge 28. The second indicia 42 is located on the panels 12, 14 such that the second hole 34 is between the second indicia and score structure 38. Also, notches may be formed in the end edges 26, 28 such that the notches point toward the directional structure 36.

A film strip 44 including a polymer matrix and an active is located within the cavity 20 of the packet structure 10. The active may be a pharmaceutical which is impregnated on a polymer matrix which is dissolvable. Alternatively, the active may be a medication for a cut or wound which is impregnated on a polymer matrix which is dissolvable or removed after the medication has been transferred to the cut or wound. The packet structure 10 and film strip 44 define a unit assembly 46.

The packet structure 10 is opened according to a method in which the detachable edge 24 is torn from the envelope structure 16. For a user which is right-handed, the packet structure 10 is oriented as shown in FIG. 1. The section of the envelope structure 16 adjacent to the first indicia 40 and end edge 26 is grasped by the left hand of the user such that the score structure 38 is between the left hand and detachable edge 24. Contemporaneously with this grasping by the left hand, the envelope structure 16 adjacent to the first indicia 40 and end edge 26 is grasped by the right hand of the user such that the right hand is between the detachable edge 24 and score structure 38. The grasping of the envelope structure 16 by the left and right hands is typically between the respective thumbs and index fingers thereof.

The left and right hands of the user are displaced away from one another in a direction which is perpendicular to the envelope structure 16. The locations of the grasping of the envelope structure 16 being adjacent to the first indicia 40 results in the displacement of the right and left hands of the user causing the initiation of a tear. The first indicia 40 indicates that the tear is to be directed toward the first hole 32. Accordingly, the user will normally adjust the relative displacement of the right and left hands to cause the direction of the tear indicated by the first indicia 40.

Continued displacement of the right and left hands of the user away from one another results in the tearing of the score structure 38 reaching the first hole 32. This results in a portion of the envelope structure 16 which is contiguous with the detachable edge 24 and end edge 26 being oriented at a substantial angle, such as 90 degrees, relative to the envelope structure, as shown in FIG. 2. This portion of the envelope structure 16, which is contiguous with the end edge 26 and detachable edge 24, defines a handle 48, as shown in FIG. 2. With the section of the envelope structure 16 to the left of the score structure 38 continuing to be grasped by the left hand of the user, the handle 48 is grasped by the right hand of the user and displaced relative to the left hand in a direction 50 which is initially toward the second hole 34. The tearing of the envelope structure 16 coincides with the score structure 38 as a result of the score structure having a reduced resistance to tearing relative to the adjoining portions of the envelope structure. Also, the first indicia 40 indicates that the tearing of the envelope structure 16 is to coincide with the score structure 38. The downward displacement of the handle 48 is continued such that the tearing of the score structure 38 reaches the second hole 34. Before the tearing of the score structure 38, the envelope structure 16 may be folded one or more times such that the fold coincides with the score structure.

The tearing of the score structure 38 between the first and second holes 32, 34 and the location of the score structure in the region of the first and second panels 12, 14 which defines the cavity 20 results in the opening thereof. Consequently, tearing of the envelope structure 16 between the second hole 34 and end edge 28 is not required to open the cavity 20 by tearing the score structure 38. Following the tearing of the score structure 38 between the first and second holes 32, 34, the cavity 20 may be opened by peeling apart the first and second panels 12, 14, such as the sections thereof which were contiguous with the score structure 38 before the tearing thereof.

The tearing of the envelope structure 16 may be initiated by tearing the section thereof which intersects the end edge 28 according to the method disclosed herein for tearing the envelope structure by initially tearing the section thereof which intersects the end edge 26. Consequently, a right-handed user would typically grasp the section of the envelope structure 16 adjacent to the second indicia 42 and end edge 28 by the left hand such that the score structure 38 is between the left hand and detachable edge 24. Contemporaneously with this grasping by the left hand, the envelope structure 16 adjacent to the second indicia 42 and end edge 28 is grasped by the right hand of the user such that the right hand is between the detachable edge 24 and score structure 38. The left and right hands of the user are displaced away from one another, as indicated by the second indicia 42, to initially tear the envelope structure between the end edge 28 and second hole 34 to form the handle 48. The handle 48 is displaced, initially toward the first hole 32, in a direction which is opposite to the direction 50 for tearing the envelope structure 16. The tearing of the envelope structure 16 coincides with the score structure 38 and continues such that the tear reaches the first hole 32. This results in the opening of the cavity 20. The envelope structure 16 may have various orientations for the tearing thereof to open the cavity 20 according to the method disclosed herein. These orientations include either the end edge 26 being above the end edge 28, or the end edge 28 being above the end edge 26. Also, the orientation of the envelope structure 16 may be vertical, horizontal, or inclined.

The opening of the packet structure 10 by a left-handed user is typically provided by orienting the envelope structure 16 such that the detachable edge 24 is to the left of the lateral edge 22. This provides for the grasping of the section of the envelope structure 16 between the detachable edge 24 and score structure 38 by the left hand of the left-handed user in a manner corresponding to the grasping of the envelope structure 16 by the right hand of a right-handed user according to the method disclosed herein. The right hand of the left-handed user grasps the envelope structure 16 between the lateral edge 22 and score structure 38 in a manner corresponding to the grasping of the envelope structure 16 by the left hand of a right-handed user according to the method disclosed herein. The envelope structure 16, when grasped by the left-handed user, may have various orientations which correspond to the orientations of the envelope structure when grasped by the right-handed user according to the method disclosed herein.

The opening of the cavity 20 by the tearing of the score structure 38 provides access to the film strip 44 which is located within the cavity. The film strip 44 is removed from the cavity 20 by the hand of the user which had previously grasped the handle 48. This is provided by the release of the handle 48 by the associated hand and inserting the thumb and index finger thereof into the cavity 20. The film strip 44 is grasped between the thumb and index finger and, subsequently, removed from the cavity 20.

Following the removal of the film strip 44 from the cavity 20, the film strip is inserted into the open mouth of the user or a second individual and, typically placed on the upper surface of the tongue of either individual. Subsequently, the hand of the user is removed from the mouth of the recipient of the film strip 44, and the mouth of the recipient is closed. This typically results in the ingestion of the film strip 44 by the recipient. Alternatively, following the removal of the film strip 44 from the cavity 20, the film strip may be placed on a cut or wound and the contiguous skin of the user or a second individual. Subsequently, the medication of the film strip 44 transfers to the cut or wound to promote the healing thereof. The polymer matrix of the film strip 44 may dissolve on the cut or wound and skin of the recipient or, alternatively, the structure of the polymer matrix may be retained for the physical removal thereof from the cut or wound and skin of the recipient.

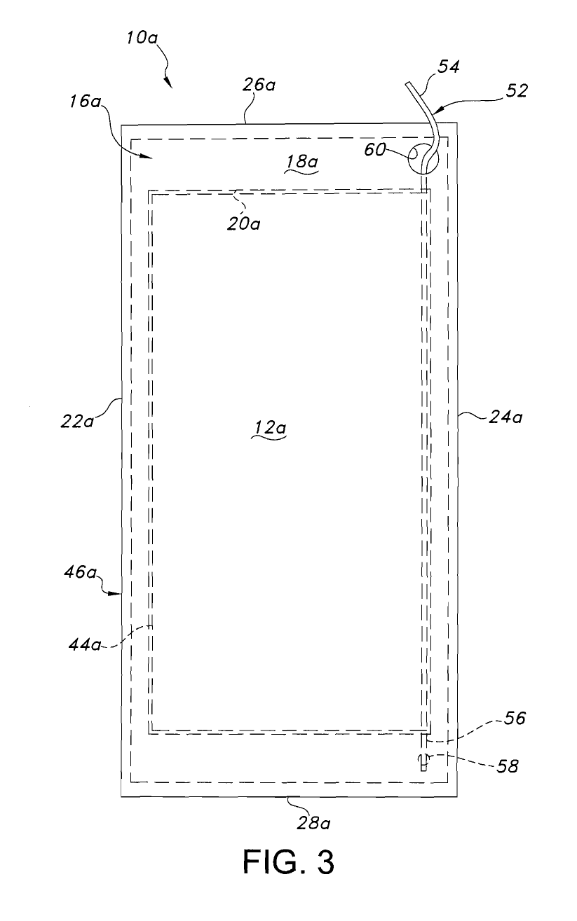

An alternative embodiment of the packet structure 10a is shown in FIG. 3. Parts illustrated in FIG. 3 which correspond to parts illustrated in FIGS. 1 and 2 have, in FIG. 3, the same reference numeral as in FIGS. 1 and 2 with the addition of the suffix “a”. In this alternative embodiment, the tear structure 30a includes a pull-string 52 which has proximal and distal end sections 54, 56. The distal end section 56 is located within the envelope structure 16a, and attached thereto by a connection 58 to the first and second panels 12a, 14a in the section of the sealed region 18a which is between the cavity 20a and end edge 28a, as shown in FIG. 3. The connection 58 is provided by an adhesive or other bonding. The pull-string 52 extends from the connection 58 through the envelope structure 16a and cavity 20a in the direction toward the end edge 26a. In alternative embodiments, additional sections of the pull-string 52 may be attached within the envelope structure 16a, such as by connecting the pull-string to the first and second panels 12a, 14a in the section of the sealed region 18a which is between the cavity 20a and end edge 26a.

The tear structure 30a includes an aperture 60 formed in the first panel 12a. More specifically, the aperture 60 is located in the section of the sealed region 18a which is between the cavity 20a and end edge 26a, as shown in FIG. 3. The pull-string 52 extends through the aperture 60 such that the proximal end section 54 is located outside of the envelope structure 16a. The locations of the aperture 60 and connection 58 in the opposing sections of the sealed region 18a provide for the attachment of the pull-string 52 to the envelope structure 16a to be located a substantial distance from the aperture 60.

The packet structure 10a is opened according to a method in which the section of the sealed region 18a which is between the cavity 20a and end edge 26a is grasped by one hand of the user and the pull-string 52 is grasped by the other hand of the user. If the user is right handed, the packet structure 10a is oriented such that the detachable edge 24a defines the right edge, as shown in FIG. 3. This provides for the left hand of the user to grasp the section of the sealed region 18a which is between the cavity 20a and end edge 26a, such as between the thumb and index and middle fingers. The proximal end section 54 of the pull-string 52 is grasped by the right hand of the user, typically between the thumb and index finger. The proximal end section 54 is pulled in a direction which is outward relative to the first panel 12a and toward the distal end section 56 of the pull-string 52. Consequently, the pull-string 52 tears through the adjacent section of the first panel 12a in an outward direction which is perpendicular thereto. The displacement of the proximal end section 54 in the direction which is away from the first panel 12a and toward the distal end section 56 is continued such that the tearing of the first panel 12a reaches the connection 58 of the pull-string 52 to the first panel and second panel 14a. The tearing of the first panel 12a between the aperture 60 and connection 58, and the location of the pull-string 52 in the region of the envelope structure 16a which defines the cavity 20a results in the opening thereof. The envelope structure 16a may have various orientations for the tearing thereof to open the cavity 20a according to the method disclosed herein. These orientations include either the end edge 26a being above the end edge 28a, or the end edge 28a being above the end edge 26a. Also, the orientation of the envelope structure 16a may be vertical, horizontal or inclined.

The opening of the packet structure 10a by a left-handed user is typically provided by orienting the envelope structure 16a such that the detachable edge 24a is to the left of the lateral edge 22a. This provides for the grasping of the section of the sealed region 18a which is between the cavity 20a and end edge 26a by the right hand of the left-handed user in a manner corresponding to the grasping of this section of the sealed region 18a by the left hand of a right-handed user according to the method disclosed herein Also, the distal end section 56 of the pull-string 52 is grasped by the left hand of the left-handed user in a manner corresponding to the grasping of the pull-string by the right hand of a right-handed user according to the method disclosed herein. The envelope structure 16a, when grasped by the left-handed user, may have various orientations which correspond to the orientations of the envelope structure when grasped by the right-handed user according to the method disclosed herein.

The opening of the cavity by the tearing of the first panel 12a between the aperture 60 and connection 58 provides access to the film strip 44a which is located within the cavity 20a. The film strip 44a is removed from the cavity 20a by the hand of the user which had previously grasped the pull-string 52. This is provided by the release of the pull-string 52 by the associated hand and inserting the thumb and index finger thereof into the cavity 20a. The film strip 44a is grasped between the thumb and index finger and, subsequently, removed from the cavity 20a. Following the removal of the film strip 44a from the cavity 20a, the film strip is employed by the user or a second individual according to a method which corresponds to the employment of the film strip 44a by the user or second individual following the removal of the film strip 44a from the cavity 20a.

While the invention has been described by reference to certain preferred embodiments, it should be understood that numerous changes could be made within the spirit and scope of the inventive concept described. Accordingly, it is intended that the invention not be limited to the disclosed embodiments, but that it have the full scope permitted by the language of the following claims.

What is claimed is:

1. A packet structure comprising:
an envelope structure; and
a tear structure formed in said envelope structure, said tear structure having a reduced resistance to tearing relative to an adjoining portion of said envelope structure.

2. A packet structure according to claim 1, wherein said tear structure comprises a score structure.

3. A packet structure according to claim 1, wherein said tear structure comprises a hole formed in said envelope structure,
said tear structure further comprising a directional structure which has a reduced resistance to tearing relative to an adjoining portion of said envelope structure, said directional structure intersecting said hole.

4. A packet structure according to claim 1, wherein said tear structure comprises a directional structure which has a reduced resistance to tearing relative to an adjoining portion of said envelope structure,
said tear structure further comprising an indicia affixed to said envelope structure such that said indicia indicates a direction in which said directional structure is to be torn.

5. A packet structure according to claim 1, wherein said envelope structure has an internal cavity and an outer sealed region,
said tear structure being located in said sealed region,
said tear structure being continuous and further located in said envelope structure which defines said cavity.

6. A packet structure according to claim 5, wherein said tear structure comprises a directional structure which has a reduced resistance to tearing relative to an adjoining portion of said envelope structure,
said directional structure being located in said sealed region,
said directional structure being continuous and further located in said envelope structure which defines said cavity,
said tear structure further comprising a hole formed in said sealed region such that said hole intersects said directional structure.

7. A packet structure according to claim 5, wherein said tear structure comprises a directional structure which has a reduced resistance to tearing relative to an adjoining portion of said envelope structure,
said directional structure being located in said sealed region,
said directional structure being continuous and further located in said envelope structure which defines said cavity,
said tear structure further comprising an indicia affixed to said envelope structure such that said indicia indicates a direction in which said directional structure is to be torn.

8. A packet structure comprising:
an envelope structure; and
a tear structure comprising a pull-string located within said envelope structure and attached thereto,
said tear structure further comprising an aperture formed in said envelope structure such that said pull-string extends through said aperture to a location outside of said envelope structure,
said location of said pull-string outside of said envelope structure providing for a grasping of said pull-string for displacement thereof relative to said envelope structure for tearing thereof.

9. A packet structure according to claim 8, wherein said attachment of said pull-string to said envelope structure is located a substantial distance from said aperture.

10. A packet structure according to claim 8, wherein said envelope structure has an internal cavity and an outer sealed region,
said pull-string being located in said sealed region and cavity.

11. A method for opening a packet structure including an envelope structure which has an internal cavity and an outer sealed region, the envelope structure having an end edge,
the packet structure having a tear structure located in the sealed region, the tear structure having a directional structure which is continuous and further located in the envelope structure which defines the cavity, the directional structure having a reduced resistance to tearing relative to an adjoining portion of the envelope structure,
the tear structure having a hole formed in the sealed region such that the hole intersects the directional structure,
said method comprising:
tearing the envelope structure between the end edge and hole such that a portion of the envelope structure which is contiguous with the end edge defines a handle structure; and
grasping the handle structure to further tear the envelope structure such that the tearing thereof coincides with the directional structure and intersects the cavity.

12. A method according to claim 11, wherein said grasping comprises orienting the handle structure at a substantial angle relative to the envelope structure.

13. A method for opening a packet structure including an envelope structure having an internal cavity and outer sealed region, the packet structure including a tear structure having a pull-string located within the sealed region and cavity, the pull-string being attached to said envelope structure, the tear structure including an aperture formed in the envelope structure such that the pull-string extends through the aperture to a location outside of the envelope structure,
said method comprising grasping the pull-string for displacement thereof relative to the envelope structure for tearing thereof such that said tearing intersects the cavity.
